(19) United States
(12) Patent Application Publication
(10) Pub. No.: US 2024/0220449 A1
(43) Pub. Date: Jul. 4, 2024

(54) METHOD AND APPARATUS FOR MANAGING ACCOUNTS, AND SERVER AND STORAGE MEDIUM THEREOF

(71) Applicants: ENVISON DIGITAL INTERNATIONAL PTE. LTD., Singapore (SG); SHANGHAI ENVISION DIGITAL CO., LTD, Shanghai (CN)

(72) Inventor: Weiyou MU, Shanghai (CN)

(73) Assignees: ENVISON DIGITAL INTERNATIONAL PTE. LTD., Singapore (CN); SHANGHAI ENVISION DIGITAL CO., LTD, Shanghai (CN)

(21) Appl. No.: 18/288,932

(22) PCT Filed: May 18, 2022
(86) PCT No.: PCT/SG2022/050329

§ 371 Date: Oct. 30, 2023

(30) Foreign Application Priority Data
May 20, 2021 (CN) 202110551760.1

(51) Int. Cl. G06F 16/11; G06F 16/16; G06F 21/31

(52) U.S. Cl. CPC G06F 16/122; G06F 16/164; G06F 21/31

(57) ABSTRACT

Disclosed are a method and apparatus for managing accounts, and a server and a storage medium thereof. The method includes: acquiring an account information recording file containing at least one piece of account information, wherein different account information is configured to create different user accounts; filtering and selecting target account information in the account information recording file by parsing the account information recording file, the target account information being account information that passes account information validity verification; and creating a target user account based on the target account information, the target user account having a target permission indicated by the target account information. The method can realize automatic batch verification of account information, batch creation of user accounts, and batch authorization for user accounts. Through associated creation of user accounts and authorization assignment process, there is no need for an administrator to manually assign authorization to user accounts after the user accounts are created, thereby improving the efficiency of managing user account authorization.

### TECHNICAL FIELD

Embodiments of the present disclosure relate to the field of account management technologies, and in particular, relate to a method and apparatus for managing accounts, and a server and a storage medium thereof.

### BACKGROUND

Companies need to manage more and more users as their scales increase, and division of labor and permissions of the users become increasingly complicated. Thus, how to conveniently and efficiently manage user accounts becomes critically important.

In the related art, a permission management system is provided. In the permission management system, an administrator of the company creates user accounts, and assigns various roles as well as menus and permission points of the roles to the user accounts.

Obviously, in a method in the related art, the administrator has to manually create the user accounts and assigns a corresponding permission to each of the user accounts, which is relatively inefficient, and is clearly disadvantageous in effective account management for companies with a large number of users.

### SUMMARY

Various embodiments of the present disclosure provide a method and apparatus for managing accounts, and a server and a storage medium thereof.

According to one aspect of the embodiments of the present disclosure, a method for managing accounts is provided.

The method includes: acquiring an account information recording file containing at least one piece of account information, wherein different account information is configured to create different user accounts; filtering and selecting target account information in the account information recording file by parsing the account information recording file, the target account information being account information that passes account information validity verification; and
creating a target user account based on the target account information, the target user account having a target permission indicated by the target account information.

According to another aspect of the embodiments of the present disclosure, an apparatus for managing accounts is provided.

The apparatus includes: a first acquiring module, configured to acquire an account information recording file containing at least one piece of account information, wherein different account information is configured to create different user accounts; a parsing module, configured to filter and select target account information in the account information recording file by parsing the account information recording file, the target account information being account information that passes account information validity verification; and a first creating module, configured to create a target user account based on the target account information, the target user account having a target permission indicated by the target account information.

According to still another aspect of the embodiments of the present disclosure, a server is provided. The server includes: a processor, and a memory configured to store at least one program code therein. The processor, when loading and executing the at least one program code, is caused to perform the method for managing accounts according to the above aspect.

According to yet still another aspect of the embodiments of the present disclosure, a non-transitory computer-readable storage medium is provided. The non-transitory computer-readable storage medium stores at least one program code therein. The at least one program code, when loaded and executed by a processor of a server, causes the server to perform the method for managing accounts according to the above aspect.

According to yet still another aspect of the embodiments of the present disclosure, a computer program product or a computer program is provided. The computer program product or the computer program includes at least one computer instruction stored in a computer-readable storage medium. The at least one computer instruction, when loaded and executed by a processor of a server, causes the server to perform the method for managing accounts according to any one of various optional embodiments in the above aspect.

The technical solutions according to the embodiments of the present disclosure achieve the following advantageous effects.

In the embodiments of the present disclosure, the account information recording file which may be filled with several pieces of account information is provided, such that by parsing the account information recording file, functions such as automatic batch verification of account information, batch creation of user accounts, and batch permission assignment for the user accounts are achieved. Compared with manual creation of respective user accounts in the related art, automatic creation of the user accounts may be implemented according to the embodiments of the present disclosure. In addition, because the account information contains the permissions corresponding to the user accounts, the user accounts also have the permissions indicated by the account information upon creating the user accounts. By associating the created user accounts with permission assignment, an administrator does not need to manually assign the permissions to the created user accounts, thereby improving the efficiency of the permission management of the user accounts.

### BRIEF DESCRIPTION OF THE DRAWINGS

For clearer descriptions of the technical solutions in the embodiments of the present disclosure, the following briefly introduces the accompanying drawings required for describing the embodiments. Apparently, the accompanying drawings in the following description show merely some embodiments of the present disclosure, and persons of ordinary skill in the art may still derive other drawings from these accompanying drawings without creative efforts.

FIG. 1 is a schematic diagram of an implementation environment according to an exemplary embodiment of the present disclosure;

FIG. 2 is a flowchart of a method for managing accounts according to an exemplary embodiment of the present disclosure;

FIG. 3 is a schematic diagram of an interface of a user account information importing template according to an exemplary embodiment of the present disclosure;

FIG. 4 is a flowchart of a method for managing accounts according to another exemplary embodiment of the present disclosure;

FIG. 5 is a schematic diagram of a process of acquiring an account information recording file according to an exemplary embodiment of the present disclosure;

FIG. 6 is a flowchart of a method for managing accounts according to yet another exemplary embodiment of the present disclosure;

FIG. 7 is a flowchart of a method for managing accounts according to still another exemplary embodiment of the present disclosure;

FIG. 8 is a diagram of a complete process of a method for managing accounts according to an exemplary embodiment of the present disclosure;

FIG. 9 is a structural block diagram of an apparatus for managing accounts according to an embodiment of the present disclosure; and

FIG. 10 is a structural block diagram of a server according to an embodiment of the present disclosure.

### DETAILED DESCRIPTION

For clearer descriptions of the objectives, technical solutions, and advantages of the present disclosure, the embodiments of the present disclosure are described in detail hereinafter with reference to the accompanying drawings.

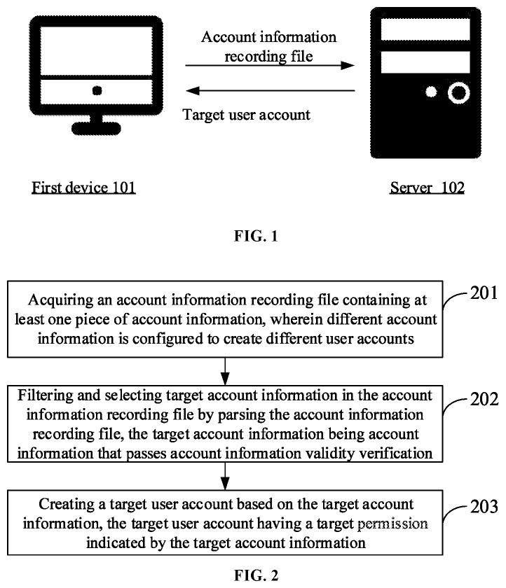

FIG. 1 is a schematic diagram of an implementation environment according to an exemplary embodiment of the present disclosure. The implementation environment involves a first device 101 and a server 102.

The first device 101 is a device installed with a permission management system or a permission management application. The first device 101 is a device of an administrator, and may be an electronic device such as a smart phone, a tablet computer, and a personal computer. In the embodiment of the present disclosure, the administrator may download a user account information importing template from a front-end interface of the first device 101, an account information recording file is generated in the case that the administrator fills in account information, and the administrator submits the account information recording file to the server 102, such that the server 102 acquires the account information recording file submitted by the administrator.

The first device 101 is connected to the server 102 in a wired or wireless fashion.

The server 102 is a business server or a background server corresponding to the first device 101, and is a device capable of receiving, storing and parsing the account information recording file, creating user accounts in batches, and assigning permissions to the user accounts in batches. The server 102 may be an independent physical server, a server cluster or distributed system composed of a plurality of physical servers, or a cloud server that provides a basic cloud computing service such as a cloud service, a cloud database, cloud computing, a cloud function, cloud storage, a network service, cloud communication, a middleware service, a domain name service, a security service, a content delivery network (CDN), and a big data and Artificial Intelligence platform. In the embodiment of the present disclosure, the server 102 receives the account information recording file from the first device 101, parses the account information recording file, filters and selects target account information available for creation of a user account, creates a corresponding target user account based on the target account information, and assigns a target permission to the target user account. In some embodiments, the server 102 may send the created target user account to the first device 101 for the administrator to view.

FIG. 2 illustrates a flowchart of a method for managing accounts according to an exemplary embodiment of the present disclosure. The embodiment of the present disclosure takes the application of the method to the server shown in FIG. 1 as an example, and the method includes the following steps.

In 201, an account information recording file containing at least one piece of account information is acquired, wherein different account information is configured to create different user accounts.

Different from the related art in which an administrator needs to input information of each user account in a foreground interface of a permission management system to create corresponding user accounts, a way of creating user accounts in batches is provided according to the embodiment of the present disclosure. That is, the permission management system provides a user account information importing template, and the administrator may fill account information of a plurality of user accounts to be imported (created) this time in the user account information importing template to generate an account information recording file; and in the case that the administrator submits the account information recording file to the server, the server, upon receiving an import operation on the account information recording file, may create the user accounts in batches based on the information of the user accounts contained in the account information recording file.

Herein, a plurality of types of user account information importing templates are provided in the permission management system, and the types of account information contained in the different user account information importing templates are different. The administrator may select, based on the type of account information required for creation of the user accounts, an appropriate user account information importing template to download, and fill the corresponding account information in the downloaded user account information importing template to generate the account information recording file.

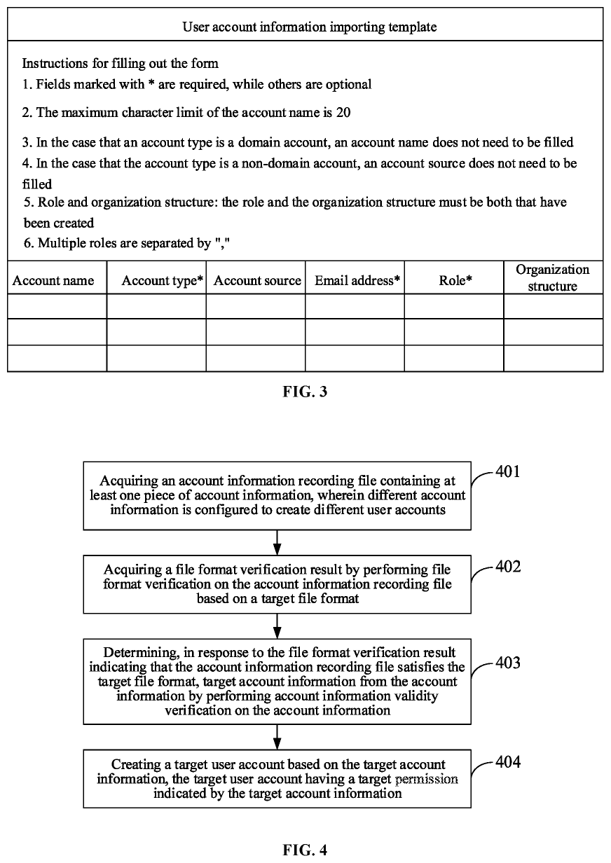

Exemplarily, FIG. 3 illustrates a schematic diagram of an interface of a user account information importing template according to an exemplary embodiment of the present disclosure. The user account information importing template includes: a template fill instruction, and various types of user account information required to be filled such as an account name, an account type, an account source, an email address, a role, and an organization structure.

In some embodiments, in the case that the administrator completes filling of the account information recording file according to the requirements of the user account information importing template, the administrator may click Submit; the corresponding background server acquires the account information recording file submitted by the administrator, stores the account information recording file in a local database, and saves file information corresponding to the account information recording file into the database, such that the corresponding account information recording file is acquired from the local database based on the file information in subsequent to perform a subsequent user account information import operation.

Herein, the file information includes a template type, a file path, a file name, a file ID, an organization identity (ID), a submitter and an import state. Herein, the template type is a template type of the user account information importing template used for the account information recording file; the file path is a storage location of the account information recording file in the local database; the file name is a name corresponding to the account information recording file; the organization ID is an identity of a company or organization to which all user account information contained in the account information recording file belongs; the submitter is a person (i.e., administrator) who fills in the account information recording file; and the import state is state information of whether the account information recording file is successfully imported in the subsequent import operation, and for example, may be an import failure, import success, etc.

In some embodiments, in the case that the administrator selects the account information recording file in the permission management system and clicks an import control, the corresponding server receives the import operation on the account information recording file, acquires the file path of the account information recording file from the database, acquires the account information recording file from the local database based on the file path, and performs a subsequent account information import operation, namely, an operation of creating the user accounts in batches.

In some embodiments, a limit is imposed on the number of lines in the account information recording file; that is, each account information recording file may store a predetermined number of lines of account information. Each line corresponds to the account information of one user account, such that each account information recording file stores account information of a predetermined number of user accounts. For example, the predetermined number is 100.

In some embodiments, the administrator may select two or more account information recording files once for account information import, which is not limited in the embodiments of the present disclosure.

In 202, target account information in the account information recording file is filtered and selected by parsing the account information recording file, wherein the target account information is account information that passes account information validity verification.

In the embodiments of the present disclosure, an automatic process of creating user accounts is provided. That is, the administrator only needs to input corresponding information of a plurality of accounts in a corresponding interface, and subsequent tasks of creating the user accounts in batches and assigning permissions in batches are automatically performed by the server. Thus, in order to ensure effectiveness and accuracy of the user accounts and the permission assignment during the creation of the user accounts based on the account information subsequently, in some embodiments, the account information recording file needs to be parsed, and account information validity verification needs to be performed on the account information in the account information recording file to filter and select the target account information that passes account information validity verification from the account information, such that a target user account corresponding to the target account information is accurately created.

In some embodiments, in the case that no account information passes the account information validity verification in the account information recording file, user accounts cannot be created in batches subsequently based on the account information recording file accordingly, and the import state corresponding to the account information recording file is a failure state; in the case that all the account information in the account information recording file passes the account information validity verification, all the account information in the account information recording file is available for subsequent user account creation accordingly, and the import state corresponding to the account information recording file is a success state; and in the case that part of the account information in the account information recording file passes the account information validity verification, this part of the account information is available for the user account creation, but some account information still fails to be imported, that is, user accounts corresponding to the account information may not be created; and thus, the account information recording file fails to be imported.

In some embodiments, because the account information recording file contains a plurality of pieces of account information, in order to improve the verification efficiency of the account information recording file by the server, in some embodiments, the account information recording file is verified by verifying the plurality of pieces of account information in parallel. In other words, when the server verifies the account information recording file, the plurality of pieces of account information in the account information recording file are verified at the same time in a parallel processing fashion, such that the verification efficiency of the account information recording file is improved, and the efficiency of the user account creation and permission assignment is further improved.

In some embodiments, the server verifies the account information recording file in a serial processing fashion. In other words, the server verifies the plurality of pieces of account information in the account information recording file one by one.

In 203, a target user account is created based on the target account information, wherein the target user account has a target permission indicated by the target account information.

The embodiments of the present disclosure are different from the related art in which creating a target user account and assigning permission are separately performed. In the embodiment of the present disclosure, because the account information recording file contains a role of a user, organization information or the like, and the role is configured to represent a permission set corresponding to the user, the target permission may be assigned to the created target user account based on the role contained in the target account information accordingly during the creation of the target user account based on the target account information; and thus, the created target user account has the corresponding target permission, thereby improving the efficiency of creating the user accounts and assigning the permissions.

In some embodiments, because the process of creating the user accounts based on the account information is performed by the server, the user accounts may be created in batches by full virtue of multi-core and multi-thread resource advantages of the server. In other words, the server may handle a task of creating account information in parallel. That is, the server may create the user accounts corresponding to a plurality of pieces of account information based on the plurality of pieces of the account information at the same time, such that the efficiency of creating the user accounts and assigning the permissions by the server is further improved.

In some embodiments, the server may handle the task of creating account information in series. In other words, the server only creates the user account corresponding to one piece of account information based on the account information at a time.

In summary, in the embodiments of the present disclosure, the account information recording file which may be filled with several pieces of account information is provided, such that by parsing the account information recording file, functions such as automatic batch verification of account information, batch creation of user accounts and batch permission assignment for the user accounts are achieved. Compared with manual creation of respective user accounts in the related art, automatic creation of the user accounts may be achieved according to the embodiments of the present disclosure. In addition, because the account information contains the permissions corresponding to the user accounts, the user accounts also have the permissions indicated by the account information upon creating the user accounts. By associating the created user accounts with permission assignment, an administrator does not need to manually assign the permissions to the created user accounts, thereby improving the efficiency of the permission management of the user accounts

In the embodiments of the present disclosure, the server automatically creates the user accounts in batches based on the filled account information. However, in the related art, an administrator manually creates user accounts and each piece of account information may be checked manually. Thus, in the embodiments of the present disclosure, during the automatic creation of the user accounts in the background, all account information in the account information recording file needs to be checked automatically in batches to ensure the accuracy of the created user accounts.

Exemplarily, FIG. 4 illustrates a flowchart of a method for managing accounts according to another exemplary embodiment of the present disclosure. The embodiment of the present disclosure takes the application of the method to the server shown in FIG. 1 as an example, and the method includes the following steps.

In 401, an account information recording file containing at least one piece of account information is acquired, wherein different account information is configured to create different user accounts.

Herein, the permission management system provides various user account information importing templates, and an administrator may select and use any user account information importing template to be filled with the account information required to be imported according to needs.

In a possible application scenario, user accounts include a domain user account and a non-domain user account. Herein, the non-domain user account is an ordinary user registered in the permission management system, and he/she logs in to a company system by using his/her account name (user name) and account passwords. The domain user account is a user registered in a specified domain which corresponds to a domain name and a uniform resource locator (URL) address; and the user account needs to be present in the specified domain, and may log in to the company system only with the specified domain. For example, in the case that an account and passwords in platform B are used for logging in to platform A, the account and passwords in platform B need to be ensured valid during the registration accordingly.

In the embodiments of the present disclosure, the import of account information of different account types may be supported, but user accounts of the different account types require different account information types during creation. For example, for the domain user account, the corresponding account source, i.e., domain name, needs to be filled; and for the non-domain user account, the corresponding account name needs to be filled for logging in to the system later with the account name.

In some embodiments, although there are two different types of user accounts, the different types of the user accounts are allowed to be filled with the same account information recording file. In the subsequent import process, the background server may automatically identify the type of each account.

Exemplarily, the user account information importing template includes: an account name, an account type, an account source, an email address, a role, and an organization structure. Herein, the account name refers to a login name of a user, and may be a name of a company member, a mobile phone number corresponding to the company member, an ID number of the company member or the like as long as the company member has an identifiable name. The account type may include a domain user account and a non-domain user account. With respect to the domain user account, the account source refers to a name of a domain where the domain user is disposed, and for example, as for an account in platform B, its corresponding account source is an address name of platform B. With respect to the non-domain user account, there is no need to fill in the account source. The email address is an address for receiving an account and passwords created for a user by the permission management system. The role refers to a permission assigned to the user; different roles have different permission sets accordingly; and a user account corresponds to a role, which indicates that the user account has the permission corresponding to this role. The organization structure refers to a resource (or assets) corresponding to a user account; and for example, where a user corresponding to a user account is responsible for managing machine group A, the corresponding machine group A is the resource corresponding to the user account.

In some embodiments, in the case that the administrator fills in the user account information importing template, for the domain user account, the account type, the account source, the email address and the role are required information. Where the domain user account has a corresponding organization structure, the organization structure needs to be filled. Where the domain user account does not have the corresponding organization structure, the organization structure does not need to be filled. For the non-domain user account, the account name, the email address, and the role are required information. Whether the organization structure is filled is similar to the case of the domain user account.

In a possible application scenario, in the case that the administrator needs to import the user account information in the permission management system, an organization and the administrator are required, that is, only a user with the permission of the administrator may perform the subsequent operation of importing the user account information. Presence of the organization means that an organization or company to which the administrator belongs is a created organization, such that in a subsequent process of creating user accounts, the user accounts are associated with their corresponding organization, that is, the user accounts are associated with the company to which they belong.

In some embodiments, content such as the role or the organization structure corresponding to the user account is involved during filling of the account information. Accordingly, in order to assign the corresponding permission and a resource to a user based on the role and the organization structure subsequently and ensure the effectiveness of the assigned permission and resource, the administrator needs to maintain the role and the organization structure in advance when he/she fills in the user account information importing template. That is, whether a created role and a created organization structure are present needs to be checked in advance; and in the case that no created role or created organization structure is present, the administrator needs to create and authorize the role and the organization structure accordingly.

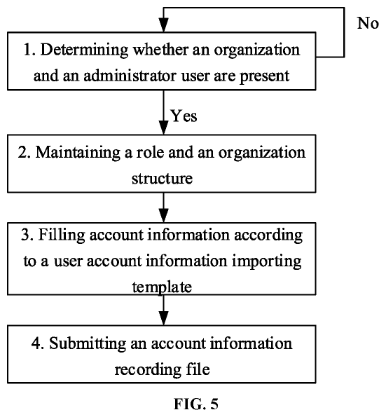

Exemplarily, FIG. 5 illustrates a schematic diagram of a process of acquiring an account information recording file according to an exemplary embodiment of the present disclosure.

1. Determining whether an organization and an administrator user are present.

In the case that the organization and the administrator user are present, a role and an organization structure need to be maintained accordingly; or otherwise, the administrator user and the organization need to be pre-registered.

2. Maintaining a role and an organization structure.

Herein, maintaining the role and the organization structure includes manually checking whether the role and the organization structure have been created, or whether the created role and organization structure are valid. In the case that no role or organization structure is present, the administrator needs to create the corresponding role and organization structure in advance, and authorize the role and the organization structure, such that the server assigns a permission to a user account based on the created role and organization structure subsequently.

3. Filling account information according to a user account information importing template.

In a process of filling the account information, the account information needs to be filled according to filling requirements corresponding to different account types, so as to ensure smooth user account import subsequently.

4. Submitting an account information recording file.

In the case that the administrator fills the account information in the user account information importing template, the account information recording file is generated. In the case that a submit control is clicked, a device of the administrator sends the account information recording file to the server, and the corresponding server may acquire the account information recording file submitted by the administrator.

In 402, a file format verification result is acquired by performing file format verification on the account information recording file based on a target file format.

Because an Excel parsing component is configured to parse the account information recording file in the embodiment of the present disclosure, a file format of the account information recording file requires to be correctly parsed by the Excel parsing component, and a file format of the corresponding account information recording file is required to be in Excel accordingly.

Herein, the target file format may be xls, xlsx, or excel.

In some embodiments, upon reading the account information recording file from the local database, the server may acquire a suffix name of the account information recording file, and compares the suffix name with the target file format. In the case that the suffix name corresponding to the account information recording file matches the target file format, the account information recording file may be parsed by the Excel parsing component. That is, the account information recording file passes the file format verification, and an account information validity verification process may be subsequently performed.

Accordingly, in the case that the suffix name corresponding to the account information recording file does not match the target file format, the account information recording file is broken or the user account information importing template adopted by the account information recording file is incorrect and cannot be parsed; then a subsequent user account import operation is stopped; and an import state corresponding to the account information recording file in the database is updated to an import failure, and the cause to the import failure is a file format error.

In 403, in response to the file format verification result indicating that the account information recording file satisfies the target file format, the target account information is determined from the account information by performing the account information validity verification on the account information.

In some embodiments, in the case that the file format corresponding to the account information recording file satisfies a requirement of the target file format, file content, namely content information, in the account information recording file may be acquired by parsing the account information recording file using the corresponding Excel parsing component. Further, the account information validity verification is performed on the account information, and the account information that passes the account information validity verification is determined as the target account information.

Herein, the account information validity verification includes information format verification and information content verification.

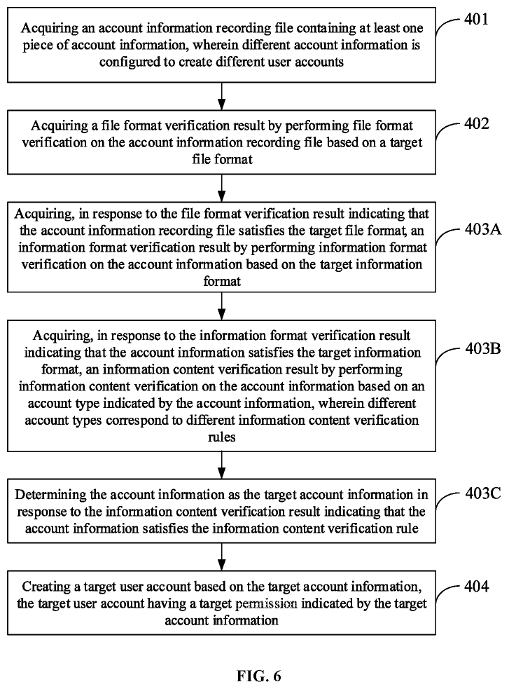

In an exemplary example, based on FIG. 4, as shown in FIG. 6, 403 includes 403A, 403B, and 403C.

In 403A, in response to the file format verification result indicating that the account information recording file satisfies the target file format, an information format verification result is acquired by performing information format verification on the account information based on the target information format.

Herein, the target information format refers to a predetermined information format that the account information needs to satisfy. For example, for the account name in the account information, whether the account name satisfies the requirement that the account name should not exceed 20 characters, or whether the account name is a recognizable name needs to be determined; and for the email address, whether the email address satisfies the email address format or the like needs to be determined.

In some embodiments, in the case that it is determined that the account information recording file may be parsed, each line of account information contained in the account information recording file may be verified to determine whether this line of the account information conforms to the target information format. In the case that this line of the account information conforms to the target information format, subsequent information content verification may be performed; or in the case that this line of the account information does not conform to the target information format, this line of account information may be marked as an abnormal line, such that this line of the account information is not to be imported subsequently.

In 403B, in response to the information format verification result indicating that the account information satisfies the target information format, an information content verification result is acquired by performing the information content verification on the account information based on an account type indicated by the account information, wherein different account types correspond to different information content verification rules.

Herein, the account types include a domain user account and a non-domain user account.

In the case of creating different types of user accounts, different kinds of account information are required. For example, the account information of the domain user account must contain the account source, while the account information of the non-domain user account must contain the account name. Thus, during the verification of specific information content of the account information, the information content needs to be verified based on the account types indicated by the account information; that is, the different account types correspond to different information content verification rules.

Exemplarily, a process of verifying information content of account information corresponding to a domain user account may include the following steps.

1. In response to the account information indicating that a user account is the domain user account, an account source and a role name contained in the account information are acquired.

Herein, the information content verification includes comprehensiveness and validity. The comprehensiveness refers to whether each line of the user account information includes all required information. The validity verification refers to determining whether the information content filled is valid, for example, determining whether the account source is present, whether the role is present, or the like.

For the check of the comprehensiveness of the information, because different account types need to be filled with different types of information content, in some embodiments, during verification of any one of lines of the account information, the server acquires an account type of this line of the account information, and determines required information that this line of the account information needs to include based on the account type. For example, taking the account type as the domain user account, the account information corresponding to the domain user account needs to include: an account type, an account source, an email address and a role. Each column of information is checked to determine whether all of the above information is present. In the case that all of the above information is present, it is determined that this line of the account information passes the check of the comprehensiveness accordingly. In the case that part of information is missing, this line of the account information is unavailable for subsequent user account creation and is an abnormal line; and thus, this line of the account information needs to be marked, and the cause to the import failure of this line of the account information is recorded as the lack of the required information.

The check of the validity is mainly to determine whether the role in the account information is present, and the role and the permission may be assigned to the user account subsequently only when the role is present. For the domain user account, because the domain user account is authorized to log in by a user account in another platform, in order to ensure the validity of the domain user account, the account source of the domain user account needs to be verified, i.e., whether the account source has been registered in the server needs to be determined in advance.

In some embodiments, in the case that it is determined that the account information type corresponding to a line is a domain user account, the role name and the account source in the account information needs to be checked accordingly, i.e., whether there is a created role name matching the role name and whether there is a created account source matching the account source in a relational database need to be determined.

In some embodiments, the above check is performed only based on the account information to be filled into the domain user account, and thus, only the role name and the account source in the account information are acquired. In some other embodiments, in the case that the account information further includes an organization structure name, the role name, the organization structure name, and the account source in the account information need to be acquired accordingly to verify whether they are valid.

2. It is determined that the account information passes the information content verification in response to the account source matching the created account source and the role name matching the created role name stored in the relational database.

In some embodiments, in the case that the account information corresponding to the type of the domain user account contains required account information and the account source and the role name contained in the account information are pre-registered in the relational database, it is determined that the account information passes the information content verification.

In some embodiments, in the case that the account information corresponding to the domain user account further includes the organization structure name based on the above required information, whether there is a created organization structure name matching the organization structure name in the relational database needs to be determined accordingly. In the case that a created organization structure name matching the organization structure name is present, the account information passes the information content verification; or in the case that no created organization structure name matching the organization structure name is present, the account information does not pass the information content verification.

Herein, the relationship database pre-stores the created role name, the created organization structure name and the created account source.

In another possible application scenario, a process of verifying the information content of the account information corresponding to the non-domain user account may include the following steps.

1. In response to the account information indicating that a user account is the non-domain user account, a role name contained in the account information is acquired.

Herein, the required account information corresponding to the non-domain user account includes an account name, an account type, an email address and the role name.

In some embodiments, in the case that it is determined that the account information belongs to the non-domain user account, first, whether the account information contains the required information corresponding to the non-domain user account needs to be determined; and in the case that the account information contains the required information, the role name contained in the account information is acquired, and the validity verification is performed on the role name.

In some embodiments, in the case that the account information further contains the organization structure name, the organization structure name, and the role name need to be acquired, and the validity verification is performed on the organization structure name and the role name.

2. It is determined that the account information passes the information content verification in response to the role name matching the created role name stored in the relational database.

In some embodiments, the relational database is searched based on the role name in the account information. In the case that the created role name matching the role name is found, it is determined that the role name is valid, and the information content verification is passed; or in the case that the created role name matching the role name fails to be found, it is determined that the role name does not have validity and is unavailable for the subsequent user account creation process.

In some embodiments, in the case that the account information contains the role name and the organization structure name, the relational database is searched based on the role name and the organization structure name. In the case that the created role name matching the role name and the created organization structure name matching the organization structure name are found, it is determined that the role name and the organization structure name are valid, or in the case that the role name or the organization structure name fails to be found, it is determined that the account information does not pass the information content verification.

In 403C, the account information is determined as the target account information in response to the information content verification result indicating that the account information satisfies the information content verification rule.

The account information recording file contains a plurality of pieces of account information, each of which corresponds to creation of one user account. Thus, during the information validity verification of each piece of the account information, normal account information (i.e., target account information) is distinguished from abnormal account information by adding a mark to the abnormal account information accordingly. That is, the account information that does not pass the account information validity verification is determined as the abnormal account information and marked, and the account information that passes the account information validity verification is determined as the target account information, such that the normal account information is filtered and selected based on the mark in the case that the account information validity verification is performed on the whole account information recording file, and is determined as the target account information.

In some embodiments, the abnormal account information may be removed from the account information recording file, and a new file is created to store the abnormal account information.

In 404, a target user account is created based on the target account information, wherein the target user account has a target permission indicated by the target account information.

The accounts according to the above embodiment are categorized into a domain user account and a non-domain user account. During creation of user accounts, user account names corresponding to different user types are different.

In view of the fact that the target user account is the domain user account, the target user account is created based on a target email address contained in the target account information. That is, the target user account uses the target email address as the user account name, such that the user logs in to the system by the target email address subsequently. In the case that the target user account is created, the target user account is associated with a target organization, namely, associating the target user account with a company to which it belongs; and a target role name is assigned to the target user account, namely, associating target permission corresponding to the target role name with the target user account.

In view of the fact that the target user account is the non-domain user account, the target user account is created based on a target account name contained in the target account information. That is, the target user account uses the account name and passwords to log in to the system. In the case that the target user account is created, the target user account is associated with the target organization, and a role name is assigned to the target user account, namely, associating the target permission corresponding to the target role name with the target user account.

In some embodiments, in the case that the user account is successfully created, a random password needs to be generated and sent to the email address indicated by the account information, such that the user securely resets a system login password.

In some embodiments, in the case that the target account information further contains a name of an organization structure, a resource permission corresponding to the organization structure needs to be assigned to the target user account, such that the target user account has a resource corresponding to the organization structure.

In the embodiments of the present disclosure, the file format verification is performed on the account information recording file, and the account information validity verification is performed on the account information in the account information recording file, such that the effective account information is filtered and selected from the account information recording file to create and authorize the user account, thereby ensuring the accuracy and effectiveness of the created user account.

In a possible application scenario, for the same account information recording file, there may part of the account information that does not pass the account information validity verification. According, with respect to this part of the account information that fails in import, the cause to the import failure (for example, an incorrect information format or the absence of the role name) needs to be notified to the administrator, such that the administrator modifies the account information based on the cause to the import failure and re-import the account information subsequently.

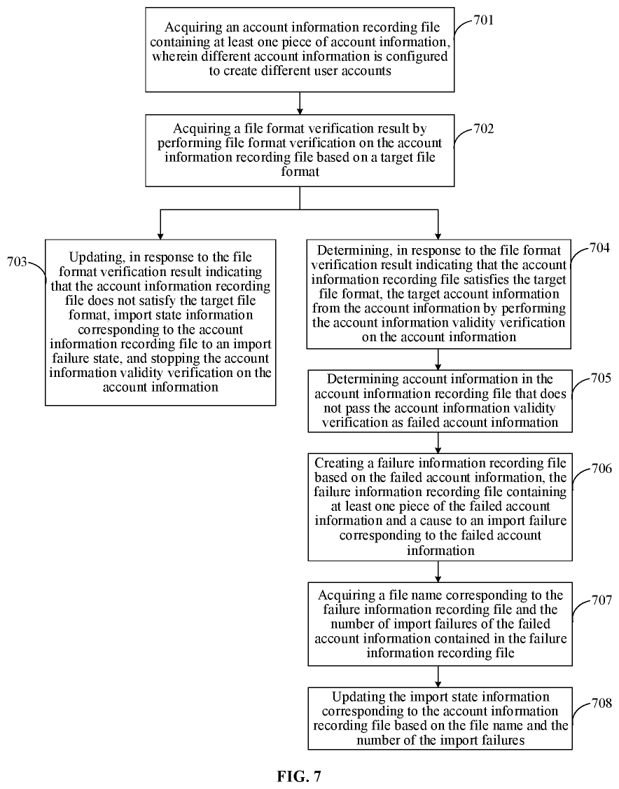

Exemplarily, FIG. 7 illustrates a flowchart of a method for managing accounts according to yet another exemplary embodiment of the present disclosure. The embodiment of the present disclosure takes the application of the method to the server shown in FIG. 1 as an example, and the method includes the following steps.

In 701, an account information recording file containing at least one piece of account information is acquired, wherein different account information is configured to create different user accounts.

In 702, a file format verification result is acquired by performing file format verification on the account information recording file based on a target file format.

For steps 701 and 702, reference may be made to the above embodiments, which is not described herein any further.

In 703, in response to the file format verification result indicating that the account information recording file does not satisfy the target file format, import state information corresponding to the account information recording file is updated to an import failure state, and the account information validity verification on the account information is stopped.

In some embodiments, upon acquiring the account information recording file, the server may save the account information recording file on itself in the form of a stream, generates a file name, and records file information in a database. The file information includes a template type adopted by the account information recording file, a save path of the file stored in the server, the file name, a file ID, an organization ID, a submitter and an import state.

When the server parses the account information recording file and determines that the file format corresponding to the account information recording file does not satisfy the target file format, it means that the account information recording file is broken and cannot be parsed. Accordingly, an import state of the account information recording file in the database needs to be updated. For example, the import state is updated as an import failure, and the account information recording file may not be parsed. Accordingly, a subsequent user account import operation may not be performed; that is, the information validity verification on the account information is stopped.

In 704, in response to the file format verification result indicating that the account information recording file satisfies the target file format, the target account information is determined from the account information by performing the account information validity verification on the account information.

For step 704, reference may be made to the above embodiments, which is not described herein any further.

In 705, account information in the account information recording file that does not pass the account information validity verification is determined as failed account information.

As known from the above, the account information validity verification includes information format verification and information content verification. In the case that the account information does not pass the information format verification or the information content verification, the account information is determined as the failed account information.

In 706, a failure information recording file is created based on the failed account information, wherein the failure information recording file contains at least one piece of the failed account information and a cause to an import failure corresponding to the failed account information.

When the server verifies each line of account information in the account information recording file and determines that a certain line of the account information does not pass the verification, this line of the account information is marked, and a new column is added in a line corresponding to this line of the account information to record a cause to a verification failure (i.e., the cause to the import failure).

In some embodiments, the failed account information may be separated from the normal account information. That is, the failed account information recording file is re-created to store the failed account information and the cause to the import failure corresponding to the failed account information, such that the administrator views an import failure record and clarifies the cause to the import failure subsequently.

Exemplarily, in a process of the account information validity verification, in the case that the information format corresponding to the account information has an error such as an email address format error, the email address format error is determined as the cause to the import failure corresponding to the failed account information, and is added to a line corresponding to the failed account information. In the case that the role name in the account information is not present, the absence of the role name is determined as the cause to the import failure, and is added to the line corresponding to the failed account information. Similarly, upon verifying the account information recording file, the server generates a failure information recording file corresponding to the account information recording file at the same time, and stores the failure information recording file therein.

In 707, a file name corresponding to the failure information recording file and the number of import failures of the failed account information contained in the failure information recording file are acquired.

In order to allow the administrator to know the whole import situation of the account information recording file clearly, in some embodiments, the import state information of the account information recording file in the database is updated based on an import success record and an import failure record.

Herein, the number of successfully imported lines, namely, the number of the pieces of successfully imported target user account information, is taken as the import success record, and the import success record is updated to the import state information corresponding to the account information recording file.

With respect to the import failure record, the file name corresponding to the failure information recording file and the number of the import failures of the failed account information need to be acquired, wherein the file name allows the administrator to conveniently download the failure information recording file subsequently, and the administrator modifies the account information based on the cause to the import failure so as to re-import the account information; and the number of the import failures allows the administrator to conveniently determine an overall import result of the account information recording file.

In 708, the import state information corresponding to the account information recording file is updated based on the file name and the number of the import failures.

In some embodiments, the server updates the import state information corresponding to the account information recording file based on the file name corresponding to the failed information recording file, the number of the import failures of the failed account information, and the number of import successes.

Exemplarily, Table 1 lists an import state information record table corresponding to the account information recording file according to an exemplary embodiment of the present disclosure.

TABLE 1

| File ID | ir15637629877981 |
|---|---|
| Organization_ID | o15578227985571 |
| Template_type | 1 |
| Source_file_name | file_AuDnUVbcKTmYtSCyrwxyG6QCxJdMVrj6 |
| Broken | 0 |
| State | 2 |
| Failure_record_file_name | file_AuDnUVbcKTmYtSCyrwxyG6QCxJdMVrj6_result |
| Result | 0.6 |
| Created_by | u15578231118721 |
| Created_at | 2020-01-06 15:01:27 |

Herein, the source file name is a file name corresponding to the account information recording file. The state of “2” indicates that the account information recording file has failed account information. The state further includes several possibilities. For example, the state of “0” indicates that the import has not started yet; the state of “4” indicates that the account information recording file is broken; the state of “1” indicates that all the account information contained in the account information recording file is successfully imported; the state of “3” indicates that there are too many lines in the account information recording file; the state of “5” indicates that there is a template error; and the state of “−1” indicates other causes. The result of “0, 6” means that there are 0 pieces of successfully imported account information and 6 pieces of account information that fail to be imported in the account information recording file.

Table 1 lists the import state information corresponding to the account information recording file stored in the database. In another possible application scenario, in the case that the server generates the import success record and the import failure record, recently imported records are displayed in the form of a list in a reverse order, such that the administrator searches a user's import record, downloads the import failure record, and analyzes the import result and the cause to the import failure. In the case that the number of the import failures is greater than 0, a download link of the failure information recording file needs to be further displayed to allow the administrator to search conveniently.

Exemplarily, Table 2 lists the import state table of the account information recording file displayed at an administrator (i.e., a device of the administrator) in an exemplary embodiment of the present disclosure.

TABLE 2

| | |
|---|---|
| File ID | ir15637629877981 |
| Template type | Role and organization structure |
| Import time | 2020-01-06 15:01 |
| The number of people | 100 |
| successfully imported | |
| The number people | 1 |
| failed to import | |
| Failure record download link | http://xxxx/file_AuDnUVbcKTmYtSCyrwxyG6QCxJdMVrj6_result |
| Source file download link | http://xxxx/ file_AuDnUVbcKTmYtSCyrwxyG6QCxJdMVrj6 |

Herein, the administrator may determine a the import state of the account information recording file is 100 people successfully imported and 1 person failed to import. Meanwhile, the administrator may acquire the failure information recording file by clicking the failure record download link so as to determine the cause to the import failure of the failed account information, modify the failed account information, and re-submit the account information to the background server for re-importing.

In some embodiments, the administrator may also modify the corresponding failed account information in the source file, re-upload the source file, and re-import the account information recording file, which supports an idempotent result.

In the embodiments of the present disclosure, in the process of verifying the account information recording file, the cause to the import failure of the failed account information is recorded at the same time to generate the failure information recording file, and the import state information of the account information recording file is updated, such that the administrator analyzes the import result and the cause to the import failure based on the import state information, thereby providing the administrator with the basis for modifying the failed account information for re-importing.

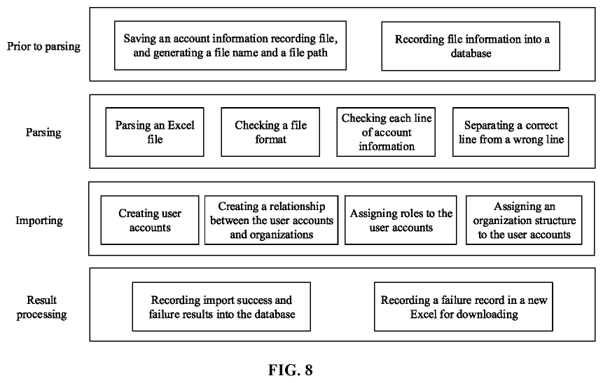

FIG. 8 illustrates a diagram of a complete process of a method for managing accounts according to an exemplary embodiment of the present disclosure.

Prior to parsing: an account information recording file uploaded by an administrator is saved into a server, a file name and a file path are generated, and file information is recorded into a database. The file information includes: a template type, the file path, the file name, a file ID, an organization ID, a submitter, and an import state.

Parsing: in a parsing process, an Excel parsing component is adopted to only parse an Excel file correspondingly, and a file format of the account information recording file needs to be checked. In the case that the account information recording file is parsed by the Excel parsing component, each line of account information in the account information recording file is checked sequentially, wherein an information format and information content corresponding to each line of the account information need to be checked; and checking the information content means that whether a role and an organization structure are valid needs to be checked. By verifying each line of the account information, a correct line is separated from a wrong line.

Importing: user accounts are created in batches based on target user account information contained in the correct line separated in the parsing process, a relationship between the user accounts and organizations is created, and roles are assigned to the user accounts. In the case that the target user account information contains the organization structure, the organization structure needs to be further assigned to the user accounts.

Result processing: import success and failure results are recorded into the database; that is, import state information corresponding to the account information recording file in the database is updated based on the import result. In the case that account information fails to be imported, a failure record is recorded into a new Excel for downloading.

The following relates to an apparatus according to an embodiment of the present disclosure, and may be configured to execute the method according to the embodiments of the present disclosure. For details not disclosed in the embodiments of the apparatus according to the present disclosure, reference may be made to the embodiments of the method according to the present disclosure.

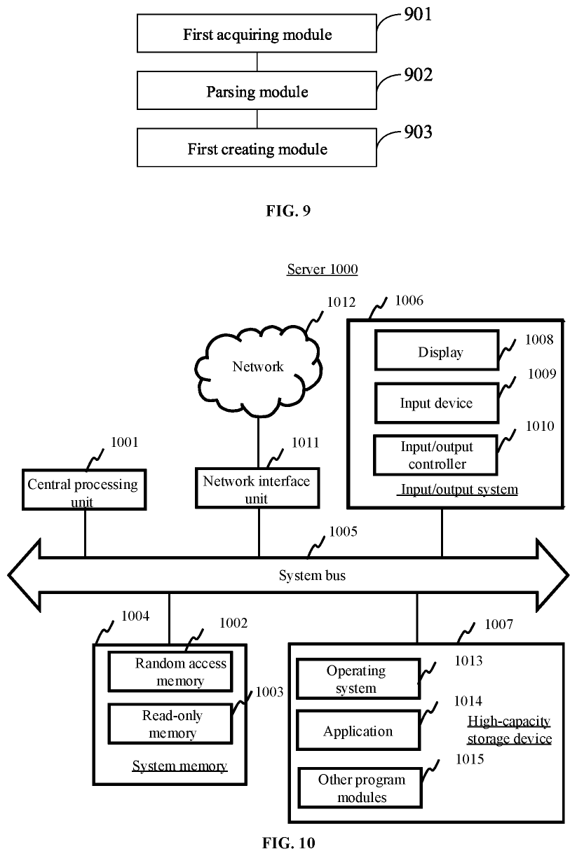

FIG. 9 illustrates a structural block diagram of an apparatus for managing accounts according to an embodiment of the present disclosure. The apparatus has a function of realizing the above method embodiments. The function may be implemented by hardware or by software executed by corresponding hardware. As shown in FIG. 9, the apparatus may include: a first acquiring module 901, a parsing module 902, and a first creating module 902.

The first acquiring module 901 is configured to acquire an account information recording file containing at least one piece of account information, wherein different account information is configured to create different user accounts.

The parsing module 902 is configured to filter and select target account information in the account information recording file by parsing the account information recording file, wherein the target account information is account information that passes account information validity verification.

The first creating module 903 is configured to create a target user account based on the target account information, wherein the target user account has a target permission indicated by the target account information.

In some embodiments, the parsing module 902 includes: a first verifying unit and a second verifying unit.

The first verifying unit is configured to acquire a file format verification result by performing file format verification on the account information recording file based on a target file format.

The second verifying unit is configured to determine, in response to the file format verification result indicating that the account information recording file satisfies the target file format, the target account information from the account information by performing the account information validity verification on the account information.

In some embodiments, the account information validity verification includes information format verification and information content verification.

The second verifying unit is further configured to: acquire an information format verification result by performing the information format verification on the account information based on the target information format; acquire, in response to the information format verification result indicating that the account information satisfies the target information format, an information content verification result by performing the information content verification on the account information based on an account type indicated by the account information, wherein different account types correspond to different information content verification rules; and determine the account information as the target account information in response to the information content verification result indicating that the account information satisfies the information content verification rule.

In some embodiments, the second verifying unit is further configured to: acquire an account source and a role name contained in the account information in response to the account information indicating that the user account is a domain user account, and determine that the account information passes the information content verification in response to the account source matching a created account source stored in a relational database and the role name matching a created role name; or acquire a role name contained in the account information in response to the account information indicating that the user account is a non-domain user account, and determine that the account information passes the information content verification in response to the role name matching a created role name stored in the relational database.

In some embodiments, the apparatus further includes: a first updating module, configured to update, in response to the file format verification result indicating that the account information record file does not satisfy the target file format, import state information corresponding to the account information record file to an import failure state, and stop performing the account information validity verification on the account information.

In some embodiments, the apparatus further includes: a determining module, configured to determine account information in the account information recording file that does not pass the account information validity verification as failed account information; and a second creating module, configured to create a failure information recording file based on the failed account information, the failure information recording file containing at least one piece of the failed account information and a cause to an import failure corresponding to the failed account information.

In some embodiments, the apparatus further includes: a second acquiring module, configured to acquire a file name corresponding to the failure information recording file and the number of import failures of the failed account information contained in the failure information recording file; and a second updating module, configured to update the import state information corresponding to the account information recording file based on the file name and the number of the import failures.

In some embodiments, the first creating module 903 includes: a first creating unit, configured to create, in response to the target user account being the domain user account, the target user account based on a target email address contained in the target account information, and associate the target permission corresponding to a target role name with the target user account; and a second creating unit, configured to create, in response to the target user account being the non-domain user account, the target user account based on a target account name contained in the target account information, and associate the target permission corresponding to the target role name with the target user account.

In summary, in the embodiments of the present disclosure, the account information recording file which may be filled with several pieces of account information is provided, such that by parsing the account information recording file, functions such as automatic batch verification of the account information, batch creation of the user accounts and batch permission assignment for the user accounts are achieved. Compared with manual creation of respective user accounts in the related art, automatic creation of the user accounts may be realized according to the embodiments of the present disclosure. In addition, because the account information contains the permissions corresponding to the user accounts, the user accounts also have the permissions indicated by the account information upon creating the user accounts. By associating the created user accounts with permission assignment, an administrator does not need to manually assign the permissions to the created user accounts, thereby improving the efficiency of the permission management of the user accounts.

It should be noted that the apparatus according to the above embodiment is descried by only taking division of all the functional modules as an example when serving its functions. In practice, the above functions may be assigned to the different functional modules to be achieved according to demands. That is, in terms of internal structure, the apparatus is divided into different functional modules to achieve all or part of the functions described above. In addition, the apparatus and the method according to the above embodiments belong to the same concept. For specific implementation of the apparatus, reference may be made to the embodiments of the method, which is not described herein any further.

FIG. 10 illustrates a structural block diagram of a server according to an embodiment of the present disclosure. This server is applicable to performing the method for managing accounts performed by the server in the above embodiments.

The server 1000 includes a central processing unit (CPU) 1001, a system memory 1004 including a random-access memory (RAM) 1002 and a read-only memory (ROM) 1003, and a system bus 1005 connecting the system memory 1004 and the CPU 1001. The server 1000 further includes a basic input/output system (I/O system) 1006 which helps transmit information between various components within the server, and a high-capacity storage device 1007 for storing an operating system 1013, an application 1014, and other program modules 1015.

The basic I/O system 1006 includes a display 1008 for displaying the information and an input device 1009, such as a mouse or keyboard, for a user to input information. The display 1008 and the input device 1009 are both connected to the CPU 1001 over an input/output controller 1010 that is connected to the system bus 1005. The basic I/O system 1006 may further include the input/output controller 1010 for receiving and processing the input from a plurality of other devices, such as a keyboard, mouse, or electronic stylus. Similarly, the input/output controller 1010 further provides output to a display screen, a printer, or other types of output devices.

The high-capacity storage device 1007 is connected to the CPU 1001 by a high-capacity storage controller (not shown) connected to the system bus 1005. The high-capacity storage device 1007 and a computer-readable storage medium associated therewith provide non-volatile storage for the server 1000. That is, the high-capacity storage device 1007 may include the computer-readable storage medium (not shown), such as a hard disk or a compact disc read-only memory (CD-ROM) drive.

Without loss of generality, the computer-readable storage medium may include a computer storage medium and a communication medium. The computer storage medium includes a volatile and non-volatile, removable and non-removable medium implemented in any method or technology for storage of information such as a computer-readable storage instruction, a data structure, a program module or other data. The computer storage medium includes an RAM, an ROM, an erasable programmable read-only memory (EPROM), an electrically erasable programmable read-only memory (EEPROM), a flash memory or other solid-state storage technologies; a CD-ROM, a digital versatile disc (DVD) or other optical storage devices; and a tape cartridge, a magnetic tape, a disk storage, or other magnetic storage devices. It would be known by a person skilled in the art that the computer storage medium is not limited to the above. The above system memory 1004 and the high-capacity storage device 1007 may be collectively referred to as the memory.

The memory stores one or more programs. The one or more programs are configured to be executed by one or more central processing units 1001, and include instructions for implementing the method according to the above embodiment. The central processing unit 1001, when loading and running the one or more programs, is caused to perform the method for managing accounts according to each of the above method embodiments.

According to the various embodiments of the present disclosure, the server 1000 may also be connected to a remote server on a network over the network, such as the Internet, for operation. That is, the server 1000 may be connected to the network 1012 over a network interface unit 1011 connected to the system bus 1005, or may be connected to other types of networks or remote server systems (not shown) over the network interface unit 1011.

The memory further includes one or more programs. The one or more programs, when loaded and run, perform the steps performed by the server.

An embodiment of the present disclosure further provides a non-transitory computer-readable storage medium. The computer-readable storage medium stores at least one program code therein. The at least one program code, when loaded and executed by a processor of a server, causes the server to perform the method for managing accounts according to each of the above embodiments.

An embodiment of the present disclosure further provides a computer program product or a computer program. The computer program product or the computer program includes at least one computer instruction stored in a computer-readable storage medium. The at least one computer instruction, when loaded and executed by a processor of a server, causes the server to perform the method for managing accounts according to any one of various optional embodiments in the above aspect.

It should be understood that the term “plurality” refers to two or more; and the term “and/or” describes association relationships of the associated objects, and may indicate three relationships. For example, “A and/or B” may indicate that A exists alone, or A and B exist simultaneously, or B exists alone. The symbol “/” generally indicates an “OR” relationship between the context objects. In addition, the serial number of steps described herein only exemplarily shows a possible execution sequence between the steps. In some other embodiments, the above steps may be executed in a reverse order to that shown in the figure, such as two steps with different serial numbers being executed at the same time, or two steps with different serial numbers being executed in a reverse order as shown in the figure, which is not limited in the embodiment of the present disclosure.

Described above are merely optional embodiments of the present disclosure, but are not intended to limit the present disclosure. Any modifications, equivalent replacements, improvements and the like made within the spirit and principles of the present disclosure should be included within the scope of protection of the present disclosure.

1. A method for managing accounts, comprising:
acquiring an account information recording file containing at least one piece of account information, different account information being configured to create different user accounts;
filtering and selecting target account information in the account information recording file by parsing the account information recording file, the target account information being account information that passes account information validity verification; and
creating a target user account based on the target account information, the target user account having a target permission indicated by the target account information, wherein filtering and selecting the target account information in the account information recording file by parsing the account information recording file comprises:
acquiring a file format verification result by performing file format verification on the account information recording file based on a target file format; and
determining, in response to the file format verification result indicating that the account information recording file satisfies the target file format, the target account information from the account information by performing the account information validity verification on the account information,
wherein
upon acquiring the file format verification result by performing the file format verification on the account information recording file based on the target file format, the method further comprises:
updating, in response to the file format verification result indicating that the account information recording file does not satisfy the target file format, import state information corresponding to the account information recording file to an import failure state, and stopping performing the account information validity verification on the account information; and
upon determining the target account information from the account information by performing the account information validity verification on the account information, the method further comprises:
determining account information in the account information recording file that does not pass the account information validity verification as failed account information; and
creating a failure information recording file based on the failed account information, the failure information recording file containing at least one piece of the failed account information, a cause to an import failure corresponding to the failed account information and a number of import failures of the failed account information;
wherein
the account information validity verification comprises information format verification and information content verification; and
determining the target account information from the account information by performing the account information validity verification on the account information comprises:
acquiring an information format verification result by performing the information format verification on the account information based on target information format;
acquiring, in response to the information format verification result indicating that the account information satisfies the target information format, an information content verification result by performing the information content verification on the account information based on an account type indicated by the account information, wherein different account types correspond to different information content verification rules; and
determining the account information as the target account information in response to the information content verification result indicating that the account information satisfies the information content verification rule.

2. The method according to claim 1, wherein acquiring the information content verification result by performing the information content verification on the account information based on the account type indicated by the account information comprises:
acquiring an account source and a role name contained in the account information in response to the account information indicating that the user account is a domain user account, and determining that the account information passes the information content verification in response to the account source matching a created account source and the role name matching a created role name stored in a relational database; or
acquiring a role name contained in the account information in response to the account information indicating that the user account is a non-domain user account, and determining that the account information passes the information content verification in response to the role name matching a created role name stored in the relational database.

3. The method according to claim 1, wherein upon creating the failure information recording file based on the failed account information, the method further comprises:
acquiring a file name corresponding to the failure information recording file and the number of import failures of the failed account information contained in the failure information recording file; and
updating the import state information corresponding to the account information recording file based on the file name and the number of the import failures.

4. The method according to claim 2, wherein creating the target user account based on the target account information comprises:
creating, in response to the target user account being the domain user account, the target user account based on a target email address contained in the target account information, and associating the target permission corresponding to a target role name with the target user account; and
creating, in response to the target user account being the non-domain user account, the target user account based on a target account name contained in the target account information, and associating the target permission corresponding to the target role name with the target user account.

5. An apparatus for managing accounts, comprising:
a first acquiring module, configured to acquire an account information recording file containing at least one piece of account information, wherein different account information is configured to create different user accounts;
a parsing module, configured to filter and select target account information in the account information recording file by parsing the account information recording file, the target account information being account information that passes account information validity verification, wherein the parsing module includes:
a first verifying unit and a second verifying unit,
the first verifying unit configured to acquire a file format verification result by performing file format verification on the account information recording file based on a target file format,
the second verifying unit configured to determine, in response to the file format verification result indicating that the account information recording file satisfies the target file format, the target account information from the account information by performing the account information validity verification on the account information;
wherein the second verifying unit is further configured to:
acquire an information format verification result by performing information format verification on the account information based on target information format;
acquire, in response to the information format verification result indicating that the account information satisfies the target information format, an information content verification result by performing information content verification on the account information based on an account type indicated by the account information;
a first updating module, configured to update, in response to the file format verification result indicating that the account information record file does not satisfy the target file format, import state information corresponding to the account information record file to an import failure state, and stop performing the account information validity verification on the account information;
a determining module, configured to determine account information in the account information recording file that does not pass the account information validity verification as failed account information; and a second creating module, configured to create a failure information recording file based on the failed account information, the failure information recording file containing at least one piece of the failed account information, a cause to an import failure corresponding to the failed account information and a number of import failures of the failed account information; and
a first creating module, configured to create a target user account based on the target account information, the target user account having a target permission indicated by the target account information.

6. A server, comprising: a processor, and a memory configured to store at least one program code therein, wherein the processor, when loading and executing the program code, is caused to perform the method for managing accounts according to claim 1.

7. A non-transitory computer-readable storage medium storing at least one program code therein, wherein the at least one program code, when loaded and executed by a processor of a server, causes the server to perform the method for managing accounts according to claim 1.

8.-10. (canceled)
